(19) United States
(12) Patent Application Publication
(10) Pub. No.: US 2010/0038448 A1
(43) Pub. Date: Feb. 18, 2010

(54) SPRAY DEVICE

(75) Inventors: Ghasem Ghavami-Nasr, Manchester (GB); Andrew J. Yule, Manchester (GB)

Correspondence Address: MICHAEL BEST & FRIEDRICH LLP, 100 E WISCONSIN AVENUE, Suite 3300, MILWAUKEE, WI, 53202, US

(73) Assignee: HUGHES SAFETY SHOWERS LIMITED, Stockport, Cheshire (GB)

(21) Appl. No.: 12/520,462

(22) PCT Filed: Dec. 20, 2007
(86) PCT No.: PCT/GB07/04910

§ 371 Date: Jun. 19, 2009

(30) Foreign Application Priority Data
Dec. 21, 2006 (GB) 0625687.9

(51) Int. Cl. B05B 1/34; B05B 9/00; B05B 9/03; B05B 9/01

(52) U.S. Cl. 239/124; 239/463; 239/302; 239/525

(57) ABSTRACT

A spray device that includes a swirl atomizer and a source of pressurized liquid. The atomizer includes a housing that defines a tubular chamber having a side wall, a first end wall, and a second end wall that opposes the first end wall. The atomizer further includes a bleed outlet channel in the second end wall that is configured to bleed an excess liquid from the atomizer, and a spray outlet channel in the first end wall. The spray outlet channel is narrower than the bleed outlet channel. The side wall includes a first face and a second face that opposes the first face. A length of the chamber between the first end wall and the second end wall is at least twice a width of the chamber between the first face and the second face of the side wall.

### BACKGROUND

The present invention relates to spray devices for generating a spray or aerosol of fine droplets, in particular for coating objects, personnel, clothing etc., for example, with a decontamination liquid and for fire suppression.

Fine sprays, which are defined herein as sprays with a mean droplet size of less than 80 microns, can act to more efficiently coat an object without wetting it significantly. Coarser sprays, for example those produced by hand-held pumps or showers, that attempt to wash off materials act in a different way from the present invention to decontaminate objects. Such sprays may be used for antibacterial, disinfectant, decontamination or other hygiene purposes. Fine sprays are also useful for cleaning particulates, for example smoke, from the atmosphere, and also for cooling the local atmosphere by droplet evaporation. such fine sprays can also be used for the suppression of fires.

Existing fine spray decontamination devices generally use either compressed air assistance to produce fine sprays or use hydraulic swirl atomizers. The former is undesirable due to the need to provide a source of compressed air. The latter is undesirable because to reduce the drop size generated by a swirl atomizer, either the supply pressure of the liquid to the swirl atomizer must be increased, resulting in liquid flow rates which are too high, or the size of the orifice through which the spray is generated must be reduced to sizes of around 0.1 mm, which is unfeasible due to the likelihood of erosion, blockage and manufacturing difficulties. High liquid flow rates result in an undesirable wetting of the surface which is to be decontaminated and in the use of high volumes of decontamination liquid which leads to problems of disposal of used decontamination liquid. Other methods use ultrasonic, electrical or electro-static atomizers to generate a fine spray, however these tend to result in complicated and relatively expensive devices which require close manufacturing tolerances and which are difficult to maintain.

### SUMMARY

These problems are avoided by the use of spill-return swirl atomizers, which bleed liquid from inside the atomizer, back to the pump reservoir, and so allow the use of high pressure so as to generate the desired small droplets (less than 80 microns and preferably less than 30 microns), but with sufficiently low flow rates (less than 0.3 liters per minute and preferably less than 0.1 liters per minute).

According to the present invention there is provided a spray device comprising at least one swirl atomizer for generating a spray of a liquid and a source of pressurised liquid for feeding the or each swirl atomizer, wherein each swirl atomizer comprises:

a housing defining a tubular chamber having a side wall and two opposing end walls;

at least one inlet channel from the source oriented in the side wall so as to generate a vortex of liquid within the chamber;

a bleed outlet channel in a second of the end walls for bleeding any excess liquid from the atomizer; and

a spray outlet channel in a first of the end walls, which is narrower than the bleed outlet channel;

and wherein the length of the chamber between the end walls is at least twice the width of the chamber between opposing faces of the side wall. The action of the bleed channel reduces the rate at which liquid is dispensed from the atomizer, while not disrupting the formation of the fine spray. This arrangement results in a very simple spray device, which is easily re-filled and maintained, is reliable and relatively cheap to manufacture. The source of pressurised liquid may comprise a reservoir of liquid and a pump for pumping liquid from the reservoir to the, or each atomizer.

Such a spray device is very useful as a decontamination device, in which case, the liquid is a decontamination liquid. Alternatively, the device can be used for spray cleaning or cooling of surfaces or of gas, e.g. of warm atmospheric air. The spray device provides good spray penetration, as well as a narrow spray angle.

In order not to waste the liquid which is bled from the atomizer, the device preferably includes a recirculation system for recirculating the excess liquid to the source. Where the source of pressurised liquid comprises a reservoir of liquid and a pump, it is preferred that the recirculation system comprises a channel extending from the, or each atomizer to the reservoir.

Each swirl atomizer comprises a housing defining a tubular chamber having a side wall, preferably a continuously curved side wall, and two opposing end walls, in which at least one inlet channel from the source is oriented in the side wall so as to generate a vortex of liquid within the chamber, a spray outlet channel is formed in a first of the end walls and a bleed outlet channel is formed in a second of the end walls, wherein the spray outlet channel is narrower than the bleed outlet channel. The narrowness of the spray outlet channel is preferably narrow enough so as to generate a high pressure portion of the chamber towards the spray outlet channel end of the chamber. The wider bleed outlet channel is dimensioned so as to form a relatively low pressure portion of the chamber at the bleed outlet end of the chamber, so as to facilitate the projection of excess fluid out of the bleed outlet channel.

The side wall may be cylindrical, and is preferably a circular cylinder (as opposed for example, to a chamber with an elliptical transverse cross-section), and each inlet channel is preferably oriented so to introduce liquid into the chamber in a direction substantially tangential to a portion of the side wall adjacent the inlet channel.

So as to form the spray at the spray outlet channel, the first end wall may taper outwardly from the chamber to an apex where the spray outlet channel is formed.

In a preferred embodiment, the chamber has a longitudinal axis of symmetry and openings from the chamber into the spray outlet channel and into the bleed outlet channel are located substantially co-axially with the longitudinal axis. By using this arrangement, the action of the bleed outlet channel occurs around the central axis of the chamber and so does not effect any vortex formed in the chamber towards the spray outlet channel, as any such vortex is formed adjacent to the side wall of the chamber. So as to facilitate smooth formation of a vortex to the spray outlet channel, the length of the chamber between the end walls is at least twice the width of the chamber between opposing faces of the side wall. Such a relatively long chamber is preferred as it allows the flow of liquid in the vortex to settle down, allows liquid to bleed off out of the bleed outlet channel and separates the spray outlet channel and the bleed outlet channel, sufficiently that the action of the bleed outlet channel has minimal effect on droplet size. Furthermore, this arrangement allows the internal flow to attain symmetry and therefore for the spray device to generate a spray which is substantially symmetrical and of a narrow angle, for example of an angle in the range of from less than about 60 degrees, particularly less than about 40 degrees.

It is preferred that the total cross-sectional area of the inlet channel(s) is at least twice the area of the spray outlet channel. This arrangement aids in the generation of a spray of a narrow angle as discussed above.

The spray outlet channel preferably has a diameter of less than 0.7 mm. This diameter of outlet can be reproduced using fairly standard manufacturing techniques, while generating a very desirable fine spray. The droplets in the spray preferably have a mass median drop size of less than 80 microns and more preferably less than 30 microns. The flow rate of the liquid from the spray outlet channel of each atomizer is preferably less than 0.3 liters per minute and more preferably less than 0.1 liters per minute. Also, the pressure of the liquid as it is fed into the, or each atomizer is preferably at least 30 atmospheres and more preferably at least 80 atmospheres.

The spray device may additionally comprise an arrangement for varying the cross-sectional area of the bleed outlet channel so as to vary the spray outlet flow rate. This arrangement can be incorporated in a shut off mechanism (as discussed below) by having a tapered or stepped portion of the spindle adjacent to the opening from the housing into the bleed outlet opening.

The devices as described above comprising an atomizer having a housing with a side wall and two end walls may additionally comprise for the, or each atomizer, a shut off system. The shut off system preferably comprises a rod having a tip shaped to close off the spray outlet opening which is slideably mounted within the chamber so as to extend substantially equidistantly between opposing surfaces of the side wall of the chamber, wherein in a first forward position, the tip of the rod closes off the spray outlet channel, and in a second rearward position, the tip of the rod moves away from the spray outlet opening so as to open the spray outlet opening without disrupting the flow of any such vortex generated within the chamber. When the rod is in its first forward position liquid fed into the atomizer bleeds out of the bleed outlet channel and may be recirculated back to the source. When the rod is in its second rearward position, a proportion of the liquid fed into the atomizer is dispensed through the spray outlet channel as a fine spray and the remainder of the liquid bleeds out of the bleed outlet channel. The rod may be conveniently slideably mounted in the second end wall of the atomizer housing and may be biased by a spring element into the forward position in which the spray outlet channel is closed off. The central location of the rod within the chamber does not damage the vortex of liquid generated in the chamber, as the vortex spirals around the walls of the chamber.

The present invention incorporating the shut off system described above, may be utilized in a hand held spray device, but comprising only a single atomizer. The device may further comprise a housing defining a handle, a forward end and a trigger mount, wherein the atomizer is mounted at the forward end and a trigger arrangement is mounted in the trigger mount such that when the trigger is not actuated the rod is in its first forward position, and when the trigger is actuated the rod moves to its second rearward position and a spray may be dispensed from the forward end of the device.

The present invention may be utilized in a trolley based spray device, for example for decontaminating a room or people located within a room and which comprises a plurality of the atomizers. In this embodiment the atomizers are mounted at an elevated position on a support trolley, which supports the source and a system for recirculating any excess liquid from the atomizers to the source. This device may additionally comprise the hand held device described above, wherein the atomizers of the devices are fed from a common source. Thus the elevated nozzles can be used to disperse a fine decontamination spray through the room and the hand held device can be used to direct a fine decontamination spray in hard to reach locations.

The present invention may also be utilized in a walk-through spray device which may comprise a plurality of the atomizers, wherein the atomizers may be mounted around a door shaped frame, so as to dispense a spray into the space within the frame. Alternatively, the atomizers may be mounted within a cubicle, so as to dispense a spray into the cubicle.

Also, the present invention may be utilized on a hand spray device which may comprise a plurality of the atomizers, wherein the device may have a housing defining a cavity suitable for receiving a pair of hands, and the nozzles may be mounted within the cavity, so as to dispense a spray into the cavity.

The liquid dispensed by the spray devices according to the present invention may be water or an aqueous solution, but other solvents, such as alcohol or ethanol may also be used. Where the spray device is a decontamination device, the liquid contains a decontamination agent.

The spray devices according to the present invention may have a cut off system for the spray outlet channel in which movement of the rod is actuated manually. Alternatively, the rod may be actuated remotely, for example, via an electromechanical, pneumatic or hydraulic actuation system.

The invention will now be described by way of example only and with reference to the accompanying schematic drawings.

### BRIEF DESCRIPTION OF THE DRAWINGS

FIG. 1A shows a representation of a decontamination device according to the present invention, incorporating a plurality of atomising nozzles;

FIG. 1B shows an enlargement of the portion of FIG. 1A labelled A;

FIG. 2A shows a longitudinal cross-section of a first design of atomising nozzle which can be used in the device of FIG. 1;

FIG. 2B shows a transverse cross-section through line A-A of FIG. 2A;

FIG. 3 shows a longitudinal cross-section of a second design of atomising nozzle, incorporating an arrangement for shutting off the nozzle, which can be used in the device of FIG. 1;

FIG. 4 shows a hand held spray device according to the present invention, which utilizes the nozzle design of FIG. 3;

FIG. 5 shows the hand held spray device of FIG. 4 connected to a support trolley and in use;

FIG. 6 shows the internal structure of a practical implementation of the decontamination device of FIG. 1 in combination with the hand held spray device of FIG. 4;

FIG. 7 shows the implementation of FIG. 6 housed within a housing;

FIGS. 8A and 8B show further embodiments of decontamination devices incorporating the nozzles of FIG. 2 in an arrangement similar to that shown in FIG. 1;

FIG. 9 shows a hand decontamination device incorporating the nozzles of FIG. 2 in an arrangement similar to that shown in FIG. 1;

FIG. 10a shows the rearward portion of a further embodiment of an atomising nozzle of the type shown in FIG. 3 in which the rod or spindle is tapered so as to vary the area from the chamber to the bleed outlet channel; and

FIG. 10b shows an alternative to the tapered portion of the rod or spindle of FIG. 10a, in which to rod or spindle has a stepped profile.

### DETAILED DESCRIPTION

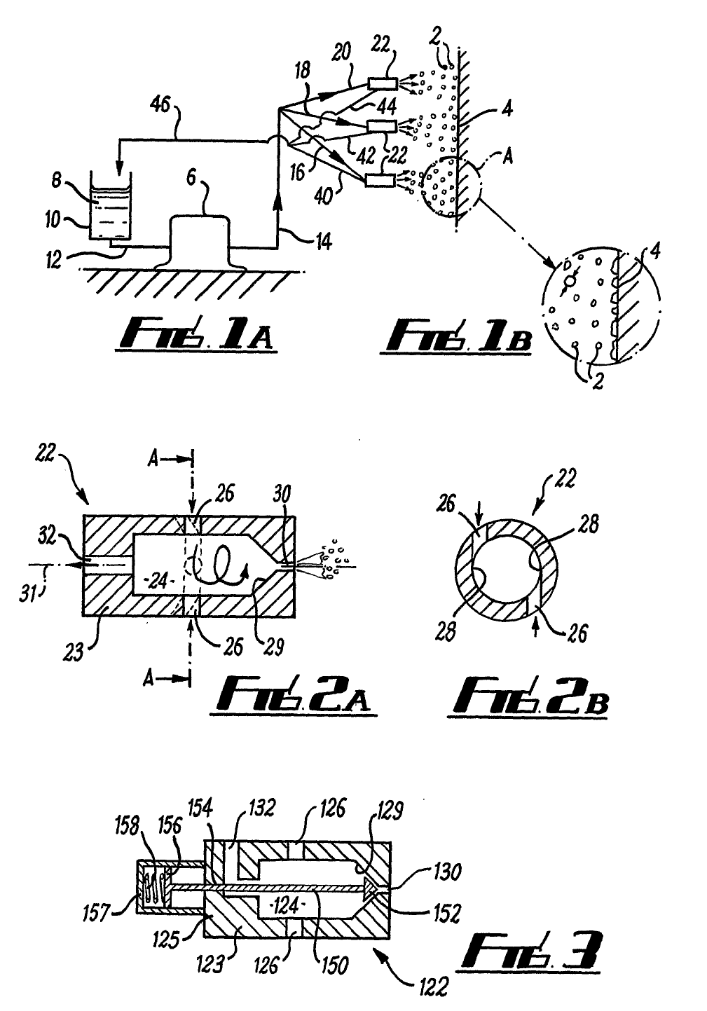

FIGS. 1A and 1B show a device for dispensing a fine spray or aerosol of liquid droplets (2) onto a surface (4) for antibacterial, disinfectant, decontamination or other hygiene purposes and also for cleaning and cooling purposes. The device comprises a reservoir (10) for storing a liquid (8), out of which the spray is generated. The liquid (8) may include one or more chemically active ingredients which act, for example, as antibacterial, disinfectant or decontamination agents. The device further comprises a pump (6) for pumping the liquid (8) from the reservoir, via first and second supply lines (12, 14), and distribution lines (16, 18, 20) to a plurality of atomising nozzles (22).

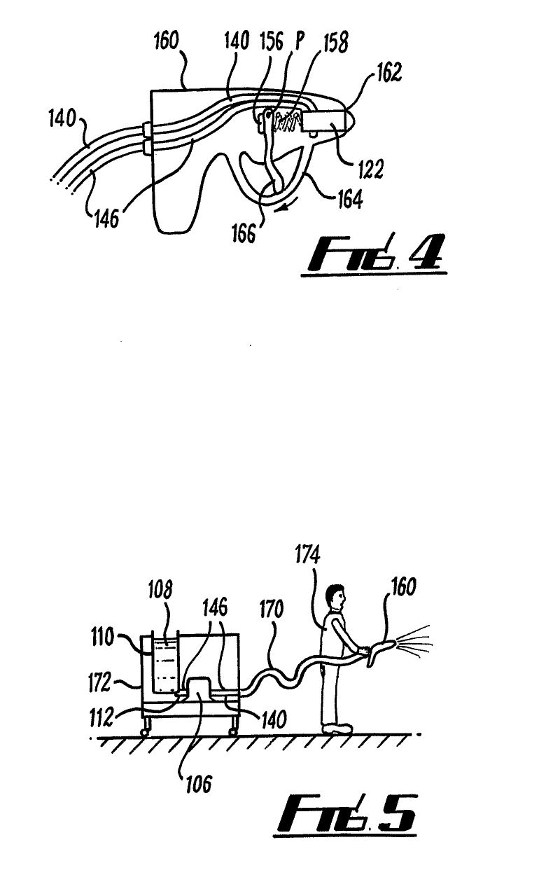

Each nozzle (22), as shown in more detail in FIGS. 2A and 2B, comprises a nozzle housing (23) defining a substantially cylindrical chamber (24). The housing (23) comprises a side wall having a cylindrical internal surface and a pair of end walls. The side wall is formed with one or more tangential inlet channels (26). In the embodiment of FIGS. 2A and 2B two opposing tangential inlet channels are utilized, which each extend through the side wall of the nozzle housing (23) substantially tangentially to an adjacent portion (28) of the cylindrical internal surface of the side wall of the housing (23). The cylindrical internal surface of the side wall need not be formed as a right cylinder with a circular transverse cross-section, by may also have an oval or elliptical transverse cross-section. Each channel (26) has a substantially circular transverse cross-section, although it is also desirable for the channels to have a substantially rectangular transverse cross-section. The portions (28) of the internal wall of the housing (23) are opposite each other. In FIG. 2A, the inlet channels (26) are shown extending at a right angle to the longitudinal axis (31) of the chamber (24), however it is also possible to angle the channels (26), so that they extend away from a spray outlet channel (30), as is shown in dashed lines in FIG. 2A.

A stream of the liquid (8) is continuously introduced into the chamber (24), via the two inlet channels (26) under pressure from the pump (6), so that a vortex of liquid is formed within the chamber. As the liquid is injected into the chamber, tangentially and the internal surface of the side wall has a cylindrical internal surface, a vortex of liquid is generated within the chamber, as indicated by the arrow in FIG. 2A. The vortex of liquid is located adjacent to the walls of the chamber and moves in a spiral path from the inlets towards a spray outlet (30).

The spray outlet channel (30) is formed through a first end wall of the housing (23) from which the spray is dispensed. The portion of the chamber between the inlet openings (26) and the spray outlet (30) is a high pressure portion of the chamber (24) due to the small diameter of the spray outlet (30). The first end wall is formed with a conical internal surface (29), which tapers to an apex in a direction away from the centre of the chamber (24), and the spray outlet channel (30) is formed at the apex of the conical surface (29). This conical surface directs the vortex of liquid of the spray outlet (30)

A bleed outlet channel (32) is formed through a second end wall of the housing (23) at the opposite end of the housing to the first end wall. The bleed outlet channel (32) bleeds excess liquid from the chamber (24), so that this excess liquid is not atomised, but instead is recirculated to the reservoir (10) via a set of return lines (40-46). The bleed outlet (32) has a larger diameter than the spray outlet (30) and so that portion of the chamber between the inlet openings (26) and the bleed outlet is a lower pressure portion of the chamber (24). A vortex of liquid extending from the inlet openings (26) to the bleed outlet (32) is also formed which acts to squirt excess liquid into the return lines (40-46) and back to the reservoir (10) for recirculation. The bleed outlet channel (32) is located in a low pressure region of the chamber (24), opposite to the spray outlet channel (30) such that the presence of the bleed opening (32) does not disrupt the angular momentum of the liquid (8) in the vortex to the spray outlet (30).

The opening from the chamber (24) into the bleed outlet channel (32) and the opening from the chamber (24) into the spray outlet chamber (30) are co-axial and lie on the longitudinal axis of symmetry (31) of the chamber (24). The co-axial location of the bleed outlet channel (32) prevents the bleeding of excess fluid through the channel from disrupting the vortex of liquid to the spray outlet channel (30).

The droplets (2) are produced by energy supplied to the liquid (8) by the pump (6). The pump (6) supplies liquid (8) to the inlet nozzles (26) at sufficiently high pressure for a fine spray dispersion to be dispensed from the spray outlet channel (30) so as to provide an even coating of droplets (2) for the surface (8), without excessive liquid deposition. The pressure generated by the pump (6), as measured at the interface between the feed lines (16, 18, 20) and the inlet channels (26) is preferably not less than 30 atmospheres, and more preferably not less than 80 atmospheres. This generates a mass median drop size of preferably not more than 80 microns and more preferably not more than 30 microns.

The bleed outlet channel (32) is required in order to generate the required small droplet size at the required low liquid flow rate, while maintaining a spray outlet nozzle diameter, of less than 0.7 mm and preferably less than 0.3 mm, which can be generated using mass production techniques. The proportion of the liquid (8) fed into the chamber (24) which is bled off via the bleed outlet channel (32) can be determined by setting the transverse cross-sectional area of the bleed outlet channel (32), or by generating a restriction in the flow of liquid along the bleed outlet channel (32) or the return lines (40-46). In a preferred embodiment, the exit orifice to the spray outlet channel (30) is no less than 0.2 mm in diameter and the spray flow rate is not more than 0.3 liters per minute, with at least half of the liquid (8) fed into the chamber (24) being bled off via the bleed outlet channel (32) and recirculated to the reservoir (10).

As an alternative to the spray nozzle (22) shown in FIGS. 1A, 2A and 2B, the design of nozzle (122) shown in FIG. 3 can be used. The nozzle (122) of FIG. 3, has a housing (123) defining a chamber (124) of a shape, with tangential inlet channels and with a spray outlet channel (130) similar to those of FIGS. 2A and 2B. The bleed outlet channel (132), is also similar to that shown in FIGS. 2A and 2B, except that the channel (132) is formed with a 90° bend in it. Thus, the spray nozzle (122) operates in the same way as the spray nozzle (22), except that the spray nozzle (122) can be shut off by a shut off mechanism.

The shut off mechanism, comprises a spindle (150) which extends co-axially along the longitudinal axis of the chamber (124) and co-axial with the spray outlet channel (130) and the opening from the bleed outlet channel (132) into the chamber (124). A forward end of the spindle (150) has a conical tip (152) which is dimensioned to mate with the portion of conical end wall (129) surrounding the entrance of the spray outlet channel (130) so as to block the spray outlet channel. The spindle (150) is slideably mounted within a spindle channel (154), which extends rearwardly from the 90° bend in the bleed outlet channel (132) through the housing (123), so that a rearward end of the spindle (150) extends beyond the external surface of the second end wall (125) of the housing (123). The rearward end of the spindle (150) is terminated with a stop plate (156). A spring (158) is positioned behind the stop plate (156), extending from the surface of the stop plate (156) facing away from the second end wall (125) and a spring support (157). The spring support (157) is rigidly fitted to the housing (122) and acts to support the spring (158), so as to bias the spindle (150) forwardly so that the tip (152) of the spindle (150) blocks the opening to the spray outlet channel (130). A force can be applied to the stop plate (156) against the biasing force of the spring (158) so as to move the spindle (150) rearwardly, into the position shown in FIG. 3, in which the tip (152) of the spindle (150) is withdrawn from the opening of the spray outlet channel (130), so that the spray outlet channel (130) is opened. This form of shut off mechanism, with a spindle (150) which extends co-axially with the chamber (124) enables the spray from the spray outlet channel (130) to be shut off, as required, without disrupting the vortex of liquid within the chamber (124). The tip (152) is sufficiently small and is withdrawn from the spray outlet channel (30) by a sufficient distance so that when it is withdrawn into the position shown in FIG. 3, the presence of the tip (152) does not disrupt the flow of the vortex of liquid towards the spray outlet channel (30).

With the shut off mechanism in the open position shown in FIG. 3, the spray outlet channel (130) is open and the nozzle (122) operates in a similar way to the nozzle (22) described above in relation to FIGS. 2A and 2B. However, with the shut off mechanism on a closed position in which the tip (152) of the spindle (150) blocks the spray outlet channel (130), all the liquid entering the chamber (124) via the inlets (126) is bled though the bleed outlet channel (132) and recirculated back to the reservoir (10). In this way, the shut off mechanism can be used to shut off, the spray nozzles (122).

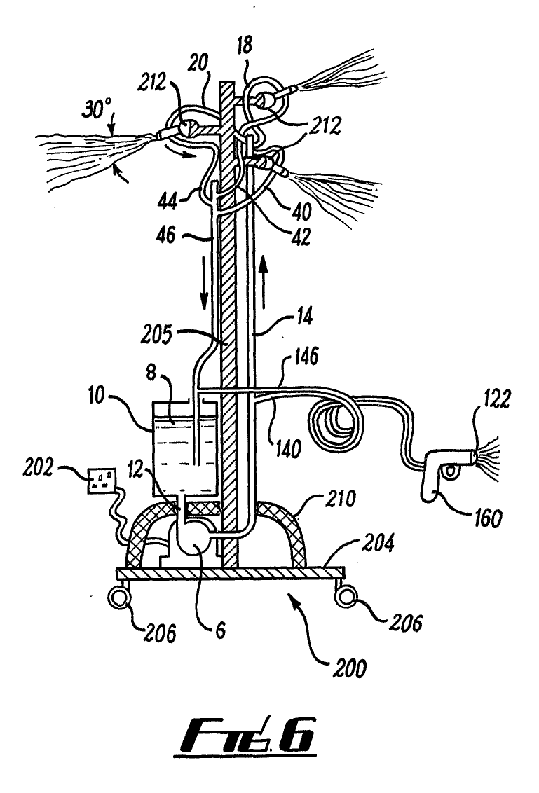

The nozzle design of FIG. 3 can be utilized in a hand held spray device, of the type shown in FIGS. 4 and 5. The spray device has a housing (160), which may be a clamshell type housing, shown with the top half of the clamshell removed in FIG. 4. The device comprises a single spray nozzle (122), mounted within the housing with the spray outlet channel end of the nozzle extending from a front outlet opening (162) of the housing. The nozzle (122) has a pair of tangential inlet channels, into which liquid is fed via supply line (140). The supply line (140) extends from the spray nozzle (122) through the housing (160) and out of the rear of the housing to a pump supply (see FIG. 5), comprising a pump (106) and a reservoir (110) which operate in similar way to that shown in FIG. 1. The nozzle (122) has a bleed outlet channel which leads into a return line (146). The return line (146) extends from the spray nozzle (122) through the housing (160) and out of the rear of the housing to the reservoir (110). The housing defines a handle (164), suitable to be gripped by a user of the hand held device, and a trigger mount, within which is pivotally mounted a trigger (166) so as to pivot about point (P). With the trigger not depressed, the shut off mechanism (156, 158) of the nozzle (122) blocks the spray outlet channel (130) of the nozzle. When a lower end of the trigger (166), which extends out of the housing (160) is depressed in the direction of the arrow in FIG. 4, a portion of the trigger (166) bears against the stop plate (156) of the shut off mechanism. The portion of the trigger (166) acts on the stop plate (156) to pull the stop plate (156) and thus the spindle (150) rearwardly, against the biasing force of the spring (158), into the position shown in FIG. 3, so as to open the nozzle (122). When the nozzle (122) is open a proportion of the liquid fed to it via the supply line (140) is dispensed from the spray outlet channel (130) of the nozzle in a fine spray, while the remainder of the liquid is bled from the nozzle via the bleed outlet channel (132).

FIG. 4 shows hand actuation of the shut off mechanism, although alternatively, the shut off mechanism could be actuated in other ways. One alternative would be to actuate the shut off mechanism using and electromechanical system, for example using a solenoid based actuation system. Other alternatives include pneumatic or hydraulic actuation systems.

As can be seen in FIG. 5, the supply line (140) and return line (146) can be held side by side within a tubular cover (170) which extends from the housing (160) of the hand held spray device to a support trolley (172). At the support trolley (172), the supply line (140) extends from the tubular cover to a pump (106) supported in the support trolley. Similarly, at the support trolley (172), the return line (146) extends from the tubular cover to a reservoir (110). A feed line (112) extends from the reservoir (110) to the pump (106). To use the hand held spray device, a user (174) switches on the pump (106) which causes liquid (108) to be drawn from the reservoir (110) and to be circulated from the pump (106), along feed line (140) to the nozzle (122) and from the nozzle (122) along the return line (146) to the reservoir (110). Then when the user depresses the trigger (166) of the device, a proportion of the liquid (108) supplied to the nozzle (122) is dispensed from the spray outlet channel (130) of the nozzle in a fine spray, and the remainder of the liquid is bled from the nozzle via the bleed outlet channel (132) and circulated back to the reservoir (110).

The rearward end of an alternative design of shut off mechanism to that shown in FIG. 3 is shown in FIG. 10a, with like parts identified with like numerals. In the FIG. 10a embodiment the spindle (150) is tapered so that movement of the spindle in the direction of the arrow will vary the area of the outlet from the chamber (124) into the bleed outlet channel (132). By varying this area, the spray flow rate through the spray outlet channel (130) can be varied. As an alternative to tapering the spindle as shown in FIG. 10a, the spindle could be stepped as shown in FIG. 10b. In FIGS. 10a and 10b, the stepped or tapered portion of the spindle (150) of the cut off mechanism is used to vary the area of the outlet from the chamber (124) into the bleed outlet channel, however, the arrangement for varying the area of this outlet need not be part of the shut off mechanism, but could instead be an independent arrangement. Also, such an independent arrangement could be located anywhere in the bleed outlet channel (132) to vary the cross-sectional area of that channel so as to vary the flow rate at the spray outlet channel.

FIG. 6 shows the decontamination device of FIG. 1 and the spray gun of FIG. 4, mounted on a support trolley (200), with like parts of FIGS. 1, 4 and 6 identified by like numerals. The support trolley (200) comprises a base (204) supported on casters (206), so that the trolley can be easily moved around. A central support pole (205) extends upwardly from the base (204).

A five liter polymer reservoir (10) is mounted on the support trolley (200) and is at atmospheric pressure, making it easy to refill. The reservoir (10) contains a decontamination liquid (8), for example a solvent, such as water or ethanol, in which a decontaminant solute is dissolved. A supply line (12) extends from base of the reservoir (10) to a pump (6), which is driven by an electric motor (not shown), powered by a mains electricity supply (202). The pump (6) is mounted on the base (204) of the support trolley (200) and is surrounded by a layer of soundproofing (210), mounted on the base (204). The layer of sound proofing (210) forms a covering for the pump (6) through which the supply lines (12, 14) and the central support pole (205) extend.

The pump (6) pumps the liquid along supply lines (14, 16, 18, 20) to three spray nozzles (22) of the type shown in FIG. 2. The supply lines (14 to 20) may, for example, be 6 mm bore stainless steel pipes. Each nozzle (22) is mounted via an associated ball and socket joint (212) to the central support pole (205). The nozzles (22) are mounted at an elevated position above the level of the reservoir (10) so that gravity aids in the return of liquid from the nozzles (22) to the reservoir (10). The ball and socket joints (212) enable the spray nozzles (22) to be directed in a desired direction. Each nozzle (22) has a 10 mm outer diameter and a length of 40 mm and is designed to generate a stream of spray, which exits the nozzle to provide spray coverage over a 30° angle. The liquid leaving the nozzles (22) via the bleed openings (32) is fed back to the reservoir (10) via return lines (40, 42, 44, 46), which are at atmospheric pressure and may for example comprise 10 mm diameter stainless steel pipes.

The supply line from the pump (6) branches off into a supply line (140) of a hand-held spray device of the type shown in FIG. 4, having housing (160). Any liquid leaving the bleed opening (132) of the nozzle (122) of the spray device is returned to the reservoir via return line (146).

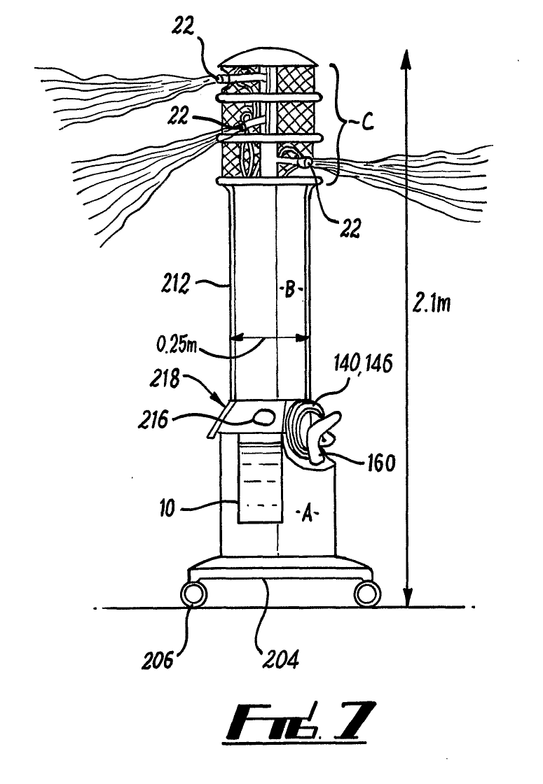

The workings of the spray device shown in FIG. 6 are preferably covered by a housing (212), as is shown in FIG. 7. The housing (212) is mounted on the base (204) of the support trolley (200) and is shaped to house the pump (6), reservoir (10), central pole (205), pipe work (12, 14, 16, 18, 20) and (40, 42, 44, 46) and nozzles (22). A widened base (A) of the housing (212) is formed with a recess or a clear panel, through which can be seen the liquid level in the reservoir (10), an openable hatch (216) through which the reservoir (10) can be refilled and a recess for stowing the hand held spray device (160) and its supply and return lines (140, 146) (see FIG. 4). A control panel (218) is mounted on the housing (212), via which the pump (6) can be switched on and off. A cylindrical central portion (B) of the housing (212) extends upwardly from the widened base portion (A) and terminates in a three tiered turret portion (C). The turret portion (C) has three vertically spaced openings, out of which a respective one of the nozzles (22) extends. The central portion (B) of the housing may have a horizontal diameter of around 0.25 m and the housing (214) may extend to a height of around 2.1 m.

The spray device of FIGS. 6 and 7 can be located in an enclosed space, for example a room, for decontaminating a room, or for decontaminating people in the room. The nozzles (22) generate a fine spray which is distributed around the room and the hand held spray device (160) can be used for decontaminating any areas, which are protected from the spray generated by the nozzles, for example, which are located under or behind objects.

Substantially, the same device can be constructed in order to cool the environment by the evaporative action of fine sprays of water or alternatively, to clean the atmosphere of particles, such as particles of tobacco smoke.

FIG. 8A shows a walk through decontamination device, comprising a door shaped support housing (300), within which are mounted a plurality of spray nozzles (22). The spray nozzles are fed with a decontaminating liquid from a reservoir contained in a support unit (302), which unit also contains a pump for pumping the liquid from the reservoir. Liquid is pumped from the reservoir in the support unit (302) via the supply line (14) into a network of supply lines, housed within the door shaped support housing (300), to the nozzles (22). The liquid bled from the nozzles (22) is fed back to the reservoir in the support unit (302) via a network of return lines, including return line (146). A person to be decontaminated (304), simply stands within the support housing (300). Any excess liquid which it dispensed through the nozzles (22) in a spray is collected in the base of the support housing (302), which base comprises a collection reservoir covered by a mesh (306) on which the person (304) stands. In an alternative embodiment to that shown in FIG. 8A, a row of cubicles (400, 404) can be provided, as shown in FIG. 8B each containing a plurality of nozzles (22) and fed by liquid from a reservoir via a pump, as described above. A person to be contaminated, simple opens the door (406) to the cubicle and walks inside, closing the door behind them and stands in the spray from the nozzles (22) for a predetermined period of time.

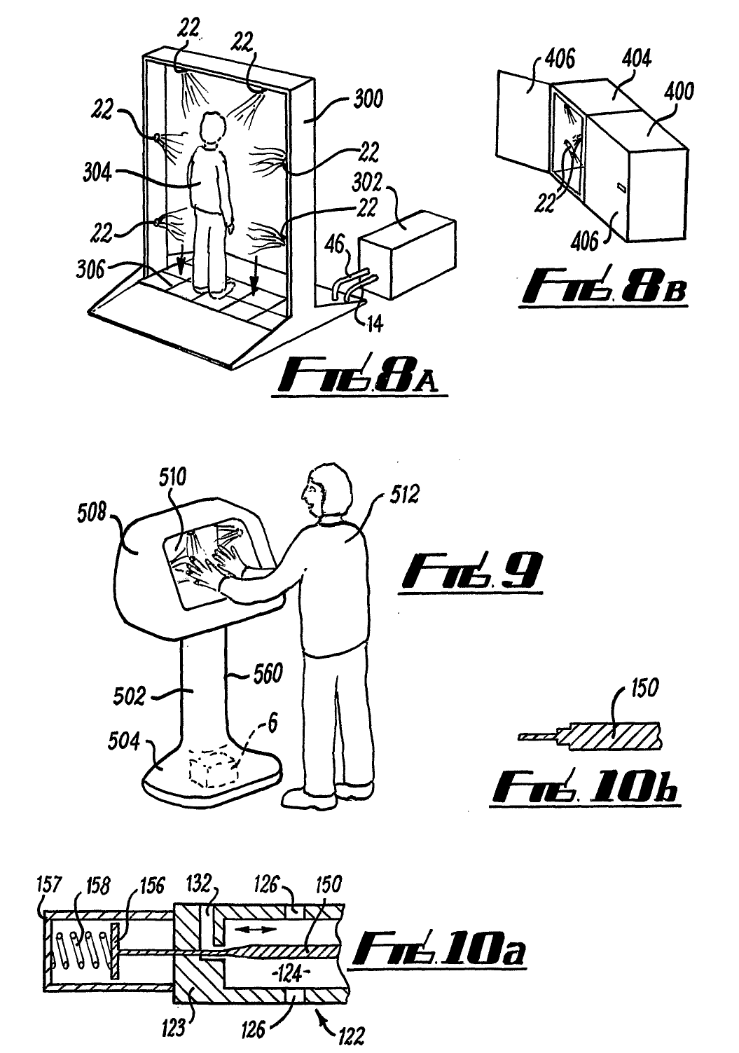

FIG. 9 shows a hand decontamination device according to a further embodiment of the present invention. The device comprises a housing (502), comprising a base (504), which houses a pump (6) and a reservoir (not shown) storing a decontamination liquid, in a similar way to the base (A) of the housing (212) of FIG. 7. Extending upwardly from the base is a central column (560) of the housing, which houses a central support pole and pipe work similar to the housing portion (B) of the housing (212) of FIG. 7. The central column (560) terminates in a housing portion (508), which defines a cavity (510), at a suitable height above the ground and of a suitable size for a person to place their hands within the cavity. The cavity (510) houses a plurality of nozzles (22) for dispensing a decontaminating spray as is described above in relation to FIG. 2. The device of FIG. 9 may for example be used in a hospital for removal of bacteria from hands, for example as a member of staff moves between different patients. The person (512) simply places there hands within the cavity (510) and activates a switch (which may be located within the cavity) for starting the pump in the base (504). Then they place their hands in the cavity (510) for a predetermined period of time, during which their hands are sprayed from the nozzles (22) by a decontaminating liquid. The person may then deactivate the pump by switching the switch or a timing device may be included for deactivating the pump after the predetermined time period.

1-26. (canceled)

27. A spray device comprising:
a source of pressurized liquid;
at least one swirl atomizer configured to generate a spray of the liquid received from the source of pressurized liquid, the at least one swirl atomizer including,
a housing that defines a tubular chamber having a side wall, a first end wall, and a second end wall that opposes the first end wall;
at least one inlet channel from the source of pressurized liquid oriented in the side wall so as to generate a vortex of liquid within the chamber;
a bleed outlet channel in the second end wall configured to bleed an excess liquid from the atomizer; and
a spray outlet channel in the first end wall, the spray outlet channel narrower than the bleed outlet channel;
wherein the side wall includes a first face and a second face that opposes the first face, and
wherein a length of the chamber between the first end wall and the second end wall is at least twice a width of the chamber between the first face and the second face of the side wall.

28. A spray device according to claim 27, further comprising a recirculation system configured to recirculate the excess liquid to the source.

29. A spray device according to claim 27, wherein the source of pressurized liquid includes a reservoir of liquid and a pump configured to pump the liquid from the reservoir to the at least one swirl atomizer.

30. A spray device according to claim 28, wherein the recirculation system includes a channel extending from the at least one swirl atomizer to the reservoir.

31. A spray device according to claim 27, wherein the side wall is cylindrical, and wherein the at least one inlet each channel is oriented so to introduce the liquid into the chamber in a direction substantially tangential to a portion of the side wall adjacent the channel.

32. A spray device according to claim 27, wherein the first end wall tapers outwardly from the chamber to an apex where the spray outlet channel is formed.

33. A spray device according to claim 27, wherein the chamber has a longitudinal axis of symmetry, and wherein an opening from the chamber into the spray outlet channel and an opening into the bleed outlet channel are both located substantially co-axially with the longitudinal axis.

34. A spray device according to claim 27, wherein the total cross-sectional area of the at least one inlet channel is at least twice the cross-sectional area of the spray outlet channel.

35. A spray device according to claim 27, wherein the spray outlet channel has a diameter of less than 0.7 mm.

36. A spray device according to claim 27, wherein the spray device is configured to generate droplets having a mass median drop size of less than 80 microns.

37. A spray device according to claim 27, wherein a flow rate of the liquid from the spray outlet channel of the at least one swirl atomizer is less than 0.3 liters per minute.

38. A spray device according to claim 27, wherein a pressure of the liquid as it is fed into the at least one swirl atomizer is at least 30 atmospheres.

39. A spray device according to claim 27, further comprising a shut off system for the at least one swirl atomizer, the shut off system including,
a rod having a tip shaped to close off the spray outlet channel, the rod slideably mounted within the chamber so as to extend substantially equidistantly between the first face and the second face of the side wall of the chamber;
wherein the rod is movable between a first forward position and a second rearward position, and
wherein in the first forward position, the tip of the rod closes off the spray outlet channel, and in the second rearward position, the tip of the rod moves away from the spray outlet channel so as to open the spray outlet channel without disrupting a flow of a vortex generated within the chamber.

40. A spray device according to claim 39, wherein the rod is slideably mounted in the second end wall of the atomizer housing.

41. A spray device according to claim 39, further comprising a spring element that biases the rod into the forward position.

42. A spray device according to claim 39, further comprising,
a housing defining a handle, a forward end, and a trigger mount; and
a trigger arrangement mounted in the trigger mount such that when the trigger is not actuated the rod is in the first forward position, and when the trigger is actuated the rod moves to the second rearward position and the spray of liquid is dispensed from the forward end,
wherein the at least one swirl atomizer is a single swirl atomizer mounted at the forward end.

43. A spray device according claim 39, wherein movement of the rod between the first forward position and the second rearward position is actuated manually.

44. A spray device according claim 39, wherein movement of the rod between the first forward position and the second rearward position is actuated remotely via one of an electromechanical, a pneumatic, and a hydraulic actuation system.

45. A spray device according to claim 27, further comprising,
a plurality of swirl atomizers;
a recirculation system configured to recirculate the excess liquid from the plurality of swirl atomizers to the source of pressurized liquid; and
a support trolley that supports the source of pressurized liquid and the recirculation system, wherein the plurality of swirl atomizers are mounted at an elevated position on the support trolley.

46. A spray device according to claim 45, wherein the plurality of atomizers are each fed from the source of pressurized liquid.

47. A spray device according to claim 27, further comprising,
a door shaped frame that forms a space within the frame; and
a plurality of swirl atomizers, wherein the plurality of swirl atomizers are mounted around the door shaped frame so as to dispense the spray into the space within the frame.

48. A spray device according to claim 27, further comprising,
a cubicle; and
a plurality of swirl atomizers, wherein the plurality of swirl atomizers are mounted within the cubicle so as to dispense the spray into the cubicle.

49. A spray device according to claim 27, further comprising,
a housing defining a cavity suitable for receiving a pair of hands; and
a plurality of swirl atomizers, wherein the plurality of swirl atomizers are mounted within the cavity so as to dispense the spray into the cavity.

50. A spray device according to claim 27, further comprising an arrangement for varying the cross-sectional area of the bleed outlet channel so as to vary a spray outlet flow rate.

51. A spray device according to claim 27, wherein the liquid includes one of a decontamination agent, a detergent, and water.
